(19) United States
(12) Patent Application Publication
(10) Pub. No.: US 2006/0267793 A1
(43) Pub. Date: Nov. 30, 2006

(54) Method and device for danger warning displays with voice output according to different degrees of urgency, especially in a motor vehicle

(76) Inventors: Volker Entenmann, Affalterbach (DE); Markus Hess, Baltmannsweiler (DE); Uwe Petersen, Steinenbronn (DE); Thomas Unselt, Stuttgart (DE); Cornelia Voigt, Aichwald (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/564,965

(22) PCT Filed: Jul. 15, 2004
(86) PCT No.: PCT/EP04/07844

§ 371 Date: Jul. 20, 2006

(30) Foreign Application Priority Data
Jul. 17, 2003 (DE) 103 32 502.6

(51) Int. Cl. G08G 1/09

(52) U.S. Cl. 340/905

(57) ABSTRACT

A display/indication and indication method for issuing danger warnings, in particular in a motor vehicle, with determination of an urgency level of the danger warning to be issued. One of a plurality of predefined display/indication modes is selected as a function of the determined urgency level and the danger warning is indicated with the selected display/indication mode. At least one of the display/indication modes includes a voice output and at least one further display/indication type which warns about the danger, with only the preferably single voice output containing information about the determined urgency level.

### BACKGROUND AND SUMMARY OF THE INVENTION

The invention relates to a method for issuing danger warnings, in particular in a motor vehicle.

Germant Patent Document DE 199 52 392 A1 discloses a method for making available route-dependent warning information for the driver of a motor vehicle. By means of digital roadmaps it is detected, for example, whether the driver is approaching a bend lying ahead. If the current velocity of the vehicle is higher than a bend limiting velocity, the driver is firstly warned visually. If the driver does not react to the visual warning within a certain time, i.e. if he continues to drive with unreduced velocity, an additional audible warning is then issued.

German patent application 102 41 133.6, which was not published at the time of the priority date of the present document, discloses a display and indication method for issuing danger warnings for a radio warning system in which an urgency level of the danger warning to be issued is determined and the type of danger warning display is selected as a function of the degree of determined chronological urgency. Distance indications are intentionally dispensed with here.

The invention is based on the object of specifying a novel display and indication method for issuing danger warnings with an improved information output and an associated display/indication device.

The invention is based on the idea that in a display and indication method for issuing danger warnings information about a degree of urgency is output only by a voice output and/or by a single voice output. In the display and indication method, one of a plurality of predefined display/indication modes—which comprises at least one voice output and a further display type—is selected as a function of the urgency level.

The implementation of different voice outputs for distinguishing between different urgency levels combined with an additional display type, for example a visual display and/or a haptic display, has the advantage that the corresponding voice output already contains the important information without the driver having to interrogate a further information source for this purpose, for example without him having to read a display unit for presenting a visual display.

The additional visual display serves only as a visual information store which the driver can access when necessary in order to freshen up information. This minimizes a distraction effect and increases the comprehensibility of the warnings and the level of acceptance of the system.

According to one advantageous development of the invention, when a first urgency level with a low degree of urgency is determined, the voice output can include a distance indication which indicates the approximate distance from the source of danger. The distance indication signals to the driver that he still has sufficient time to reduce his velocity by closing the throttle and possibly braking slightly.

When a second urgency level with a high degree of urgency is determined, the driver can be issued with a warning which signals to him that a rapid reaction is necessary and the driver must implement a braking deceleration which possibly also lies outside the normal driving comfort range.

At both urgency levels, the voice output is carried out for the purpose of keeping the distraction effect as low as possible. The different degrees of urgency are communicated by the various contents or formulations of the voice output.

In an alternative embodiment of the invention, at least one of the display/indication modes includes a single voice output which warns about the danger and includes information about the determined urgency level. The distraction of the driver is reduced further by the merely single voice output.

In addition to the information about the degree of urgency of the danger warning, it is possible, for example by means of a visual display and/or by means of the voice output, to issue information about a type of danger for both urgency levels.

In order to determine the urgency level external data, for example, is received and evaluated from other vehicles or from a control centre. Alternatively or additionally it is also possible to evaluate data from vehicle sensors which can also comprise a locating system with a digital map and/or a navigation system.

The display/indication device according to the invention includes a control/evaluation unit, a voice output unit with specific functionality and a further display unit for implementing the display and indication method.

In addition, a data receiver unit and/or a vehicle-mounted sensor unit which make available, for example to the control/evaluation unit, data for determining the urgency level and/or the distance from the danger point, may be provided. External data, for example from other vehicles or from a control centre, can also be evaluated by the data receiver unit.

### BRIEF DESCRIPTION OF THE DRAWINGS

One advantageous embodiment of the invention is illustrated in the drawings and will be described below wherein:

FIG. 1 shows a flowchart of a display and indication method for warning about dangers in a motor vehicle; and

FIG. 2 shows a schematic block diagram of a display/indication device for warning about dangers in a motor vehicle.

### DETAILED DESCRIPTION

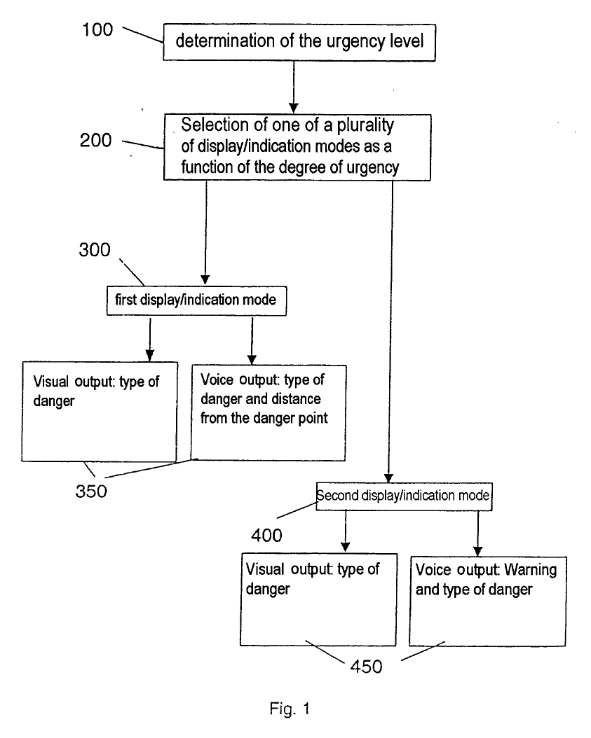

In the display/indication and indication method for issuing danger warnings which is illustrated in FIG. 1, an urgency level of the danger warning to be issued is determined in a first step 100. In a subsequent step 200, one of a plurality of display/indication modes is selected as a function of the determined degree of urgency. When a first urgency level with a low degree of urgency is determined, a first display/indication mode (step 300) is selected and a single voice output and a further display/indication type, which warn about the danger, are then activated in step 350, with only the voice output including information about the degree of urgency. The further display type is, for example, a visual display and/or haptic display. In the illustrated exemplary embodiment, an additional visual display/indication is activated and the low degree of urgency is represented by the single voice output of the distance from the danger point.

When a second urgency level is determined with a high degree of urgency, (i.e. which is higher than the above low degree of urgency) a second display/indication mode (step 400) is selected and a single voice output and a further display type, in the form of a visual display, which warn about the danger, are then activated in step 450, with only the voice output including information about the degree of urgency. In the illustrated exemplary embodiment, the high degree of urgency is represented by the single voice output of a warning.

At the first urgency level and when the associated first display/indication mode has been selected, the driver is informed by voice once about the type of danger and the distance from the danger point, for example “traffic jam in 700 meters” or “accident in 600 meters”. The visual display comprises a warning symbol with an additional text which also describes the danger, for example “traffic jam” or “accident”. The first urgency level thus has a more informative character. It is important that the distance indication is given only once by means of the voice output and is not display visually.

This approach is based on the knowledge that, on the one hand, car drivers are accustomed, from their everyday experience, to dealing with specific distance indications, for example due to distance indications on road signs, but on the other hand are bad at judging distances. Because the voice output includes the accustomed and therefore also expected distance indication, the level of acceptance of the display and indication method increases. The driver has the impression of having received all the relevant information. At the same time, the single acoustic distance indication ensures that the driver is only provided with a qualitative impression of the distance from the danger point. This property is important because the precise distance from the danger point cannot generally be determined and the driver can therefore not rely on the distance indication. For this reason acoustic updating of the distance indication or continuous display/indication of the display/indication is avoided.

At the second urgency level and when the associated second display/indication mode is selected, the driver is requested directly by the voice output of a warning to be careful and to carry on driving with greater attention. In addition, he is informed about the type of danger. Examples of the warning in the voice output of the second urgency level are “danger, traffic jam” or “danger, accident”. The use of the term “danger” signals to the driver that he must react immediately to the warning, for example by rapid and strong braking, if appropriate also beyond a usual driving comfort range since the danger point is located directly in front of him. There is no longer any voice output with a distance indication. The spatial and more importantly chronological proximity of the event is described by the warning “danger”. With the second urgency level there is also a visual display/indication which in the illustrated exemplary embodiment is identical to that from the first urgency level. It thus becomes clear that the voice output is the primary information channel via which the degree of urgency of a danger warning is communicated. The visual display is only to be seen as supplementary.

In order to determine the urgency level, in the illustrated exemplary embodiment data are evaluated from a data receiver unit and/or from a sensor unit with a locating unit with a digital map and a navigation system.

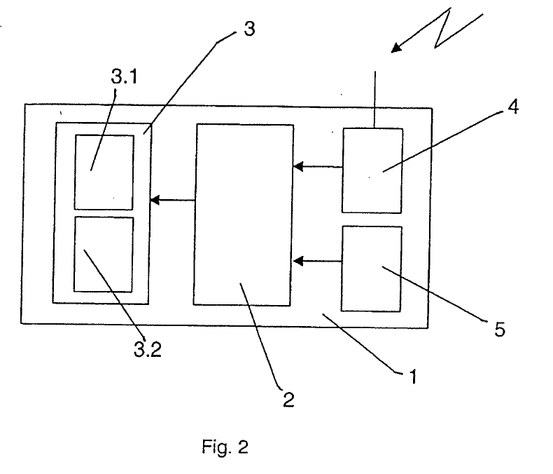

As is apparent from FIG. 2, the display/indication device shown there for issuing danger warnings in a motor vehicle 1 comprises a control/evaluation unit 2 for determining a chronological urgency level of the danger warning to be issued and for selecting one of a plurality of predefined display/indication modes as a function of the degree of urgency determined and a display/indication device 3 for issuing the danger warning with the selected display/indication mode. The display/indication device 3 includes a visual display/indication unit 3.1 and a voice output unit 3.2 which warn about the danger in at least one display/indication mode, with only the voice output unit 3.2 outputting information about the degree of urgency.

If the control/evaluation unit 2 determines a first chronological urgency level with a low degree of urgency, the visual display unit 3.1 and the voice output unit 3.2 output a display/indication about the type of danger, for example “traffic jam” or “accident”. The voice output unit 3.2 additionally outputs a distance indication which corresponds to the approximate distance of the vehicle from the danger point.

If the control/evaluation unit 2 determines a second chronological urgency level with a high degree of urgency, the visual display/indication unit 3.1 and the voice output unit 3.2 again output the display/indication about the type of danger. The voice output unit 3.2 additionally outputs a warning which signals that an immediate reaction is necessary.

In order to determine the urgency, the control/evaluation unit 2 evaluates external data which is received by a data receiver unit 4 from other vehicles and/or from a control centre. Alternatively or additionally it is possible to evaluate data from a vehicle-mounted sensor unit 5 which, for example, comprises sensors of driver assistance systems and/or of a locating unit with a digital map and/or a navigation system.

1-11. (canceled)

12. An indication method for issuing danger warnings, in particular in a motor vehicle, comprising the steps:
determining an urgency level of a danger warning to be issued,
selecting of one of a plurality of predefined indication modes as a function of the determined urgency level, and
indicating a danger warning with the selected indication mode, wherein each of the plurality of predefined indication modes include a voice output and at least one further display type which warn about a danger, with only the voice output containing information about the determined urgency level, and the voice outputs of said plurality of indication modes being different for different urgency levels.

13. An indication method for issuing danger warnings, in particular in a motor vehicle, comprising the steps:
determining an urgency level of a danger warning to be issued,
selection of one of a plurality of predefined indication modes as a function of the determined urgency level, and
indication the danger warning with the selected indication mode, wherein each of the plurality of predefined indication modes include a single voice output which warns about the danger and includes information about the determined urgency level, and the single voice outputs of said plurality of predefined indication modes are different for different urgency levels.

14. The display and indication method as claimed in claim 12, wherein, for a determined first urgency level which corresponds to a low degree of urgency an indication mode is selected in which only the voice output includes a danger distance indication which represents the low degree of urgency.

15. The indication method as claimed in claim 12, wherein, for a determined second urgency level which corresponds to a high degree of urgency, an indication mode is selected in which only the voice output voice output includes a warning which represents the high degree of urgency.

16. The indication method as claimed in claim 12, wherein, at least one of the voice output and a visual display include information about a type of danger in all the predefined selectable indication modes.

17. The indication method as claimed in claim 12, for a motor vehicle, wherein, in order to determine the urgency level, at least one of vehicle-external data and data from a vehicle-mounted sensor unit is evaluated.

18. An indication device for issuing danger warnings, comprising:
a control unit for determining an urgency level of the danger warning to be issued and for selecting one of a plurality of predefined indication modes as a function of the determined urgency level, and
an indication device for issuing the danger warning with a selected indication mode, wherein the indication device comprises a voice output device and a further display unity, and wherein the control unit only feeds an output of the output unit information about the urgency level to be output and provide different voice outputs for different urgency levels.

19. The indication device as claimed in claim 18, wherein the voice output unit outputs a distance indication which represents a low degree of urgency only if the control unit determines a first urgency level which corresponds to the low degree of urgency.

20. The indication device as claimed in claim 18, wherein, the voice output unit outputs a warning which represents a high degree of urgency only if the control unit determines a second urgency level which corresponds to the high degree of urgency.

21. The indication device as claimed in claim 18, wherein the further display unit and the voice output unit output information about a type of danger.

22. The indication device for issuing danger warnings as claimed in claim 18 for a motor vehicle, wherein, in order to determine the urgency level, the control unit evaluates at least one of vehicle- external data from a data receiver unit and data from a vehicle- mounted sensor unit.

23. The display and indication method as claimed in claim 14, wherein, for a determined first urgency level which corresponds to a low degree of urgency an indication mode is selected in which only the voice output includes a danger distance indication which represents the low degree of urgency.

24. The indication method as claimed in claim 13, wherein, for a determined second urgency level which corresponds to a high degree of urgency, an indication mode is selected in which only the voice output voice output includes a warning which represents the high degree of urgency.

25. The indication method as claimed in claim 14, wherein, for a determined second urgency level which corresponds to a high degree of urgency, an indication mode is selected in which only the voice output voice output includes a warning which represents the high degree of urgency.

26. The indication method as claimed in claim 13, wherein, at least one of the voice output and a visual display include information about a type of danger in all the predefined selectable indication modes.

27. The indication method as claimed in claim 14, wherein, at least one of the voice output and a visual display include information about a type of danger in all the predefined selectable indication modes.

28. The indication method as claimed in claim 13, for a motor vehicle, wherein, in order to determine the urgency level, at least one of vehicle-external data and data from a vehicle-mounted sensor unit is evaluated.

29. The indication device as claimed in claim 19, wherein, the voice output unit outputs a warning which represents a high degree of urgency only if the control unit determines a second urgency level which corresponds to the high degree of urgency.

30. The indication device as claimed in claim 19, wherein, the further display unit and the voice output unit output information about a type of danger.

31. The indication device for issuing dater warnings as claimed in claim 19, for a motor vehicle, wherein, in order to determine the urgency level, the control unit evaluates at least one of vehicle- external data from a data receiver unit and data from a vehicle- mounted sensor unit.
